(19) United States
(12) Patent Application Publication
(10) Pub. No.: US 2012/0164394 A1
(43) Pub. Date: Jun. 28, 2012

(54) PROTECTIVE FILM UNIT AND METHOD OF ASSEMBLING PANEL USING THE SAME

(75) Inventors: Youn-Bum Lee, Yongin-city (KR); Shawn Kim, Yongin-city (KR); Hwa-Young Kim, Yongin-city (KR)

(73) Assignee: Samsung Mobile Display Co., Ltd., Yongin-city (KR)

(21) Appl. No.: 13/267,275

(22) Filed: Oct. 6, 2011

(30) Foreign Application Priority Data
Dec. 22, 2010 (KR) 10-2010-0132825

(51) Int. Cl. B32B 3/00; B23P 11/00

(52) U.S. Cl. 428/189; 29/428

(57) ABSTRACT

A protective film unit that may protect an active area of a panel during processes that are sequentially performed through a multiple protective film, and a method of assembling a panel using the protective film unit are disclosed. The protective film unit is attached to a panel comprising a first area and a second area surrounding the first area and includes: an inner film attached to the entire surface of the first area, where a first adhesive material is entirely deposited on a first surface of the inner film corresponding to the first area; and an outer film attached to a second surface of the inner film and to the second area, wherein a second adhesive material is entirely deposited on the outer film and the first surface.

### CROSS-REFERENCE TO RELATED APPLICATIONS

This application claims the benefit of Korean Patent Application No. 10-2010-0132825, filed on Dec. 22, 2010, in the Korean Intellectual Property Office, the disclosure of which is incorporated herein in its entirety by reference.

### BACKGROUND

1. Field

The present disclosure relates to a protective film unit and a method of assembling a panel using the same, and more particularly, to a panel protective film unit used in a process of assembling a panel and a frame, and a method of assembling the panel using the panel protective film unit.

2. Description of the Related Technology

Touch screens are devices that directly input users' commands when an image display screen thereof is touched by a hand or an object. A touch screen may include a touch panel, a frame, and a flat display panel. The touch panel is attached on a front surface of the flat display panel, and converts a contact position where a user directly touches into an electrical signal. Thus, a command selected in the contact position is input as an input signal. The frame provides an area for coupling the flat display panel and the touch panel. Except for edges of the frame, all surfaces thereof are open, and the frame is attached to the touch panel by using an adhesive material. The frame to which the touch panel is attached is coupled to the flat display panel.

A single protective film is attached to the touch panel in order to protect the touch panel from an external environment during a manufacturing process. However, since a frame should be directly attached in an inactive area of the touch panel, the single protective film should be removed in a process of attaching the frame to the touch panel. As such, when the touch panel, from which the protective film is removed, is removed and is then coupled to the frame, an active area of the touch panel is exposed to the outside due to the frame of which all surfaces are open. If the touch panel is transferred or other processes are performed when a central portion of the touch panel is exposed, the active area of the sensitive touch panel is damaged, thereby resulting in defects of the touch panel.

### SUMMARY OF CERTAIN INVENTIVE ASPECTS

The present disclosure provides a protective film unit that may protect an active area of a panel during processes that are sequentially performed through a multiple protective film, and a method of assembling a panel using the protective film unit.

According to one aspect, there is provided a protective film unit attached to a panel including a first area and a second area surrounding the first area, the protective film unit including: an inner film attached to the entire surface of the first area, wherein a first adhesive material is entirely deposited on a first surface of the inner film corresponding to the first area; and an outer film that is attached to a second surface of the inner film and to the second area, wherein a second adhesive material is entirely deposited on a first surface of the outer film corresponding to the second area and the second surface of the inner film.

The first adhesive material may include a combination of a urethane-based material and a silicon-based material.

The second adhesive material may include at least one of an acrylic-based material and a urethane-based material.

An area of the inner film may be smaller than that of the outer film.

The inner film may have an area corresponding to the first area of the panel.

The protective film unit may further include a separating member formed at an edge of the second surface of the inner film, wherein the separating member comprises a contact portion attached to the second surface of the inner film, and a separating portion of which one end is connected to the inner film through the contact portion and the other end is spaced apart from the inner film and is configured to be gripped.

The protective film unit may further include a separating tag that is integrally formed with the outer film by extending an edge of the outer film, where the separating tag has a cantilever shape.

The protective film unit may further include a release film attached to the first surface of the inner surface and the first surface of the outer film that is exposed to the outside without being covered by the inner film, wherein the release film, the inner film, and the outer film are sequentially stacked.

According to another aspect, there is provided a method of assembling a panel using a protective film unit, the method including: providing a panel including a first area and a second area surrounding the first area on a surface thereof; providing a protective film unit in which a release film, an inner film, and an outer film are sequentially stacked; removing the release film; attaching the protective film unit, in which the inner film and the outer film are stacked, to the panel; removing the outer film; and attaching a frame to the second area of the panel when the inner film is attached to the first area of the panel, wherein the protective film unit comprises: an inner film attached to the entire surface of the first area, wherein a first adhesive material is entirely deposited on a first surface of the inner film corresponding to the first area; and an outer film attached to a second surface of the inner film and to the second area, wherein a second adhesive material is entirely deposited on a first surface of the outer film corresponding to the second area and the second surface of the inner film.

The first adhesive material may include a combination of a urethane-based material and a silicon-based material.

The second adhesive material may include at least one of an acrylic-based material and a urethane-based material.

The inner film may further include a separating member formed at an edge of the second surface of the inner film.

The method may further include removing the frame attached to the second area of the panel from the panel when the inner film is attached to the first area of the panel; removing the inner film by gripping the separating member of the inner film attached to the first area of the panel; and reattaching the frame to the second area of the panel from which the inner film is removed.

The outer film may further include a separating tag that is integrally formed with the outer film by extending an edge of the outer film and the separating tag may have a cantilever shape.

The removing of the outer film may include removing the outer film by gripping the separating tag.

### BRIEF DESCRIPTION OF THE DRAWINGS

The above and other features and advantages will become more apparent by describing in detail certain embodiments with reference to the attached drawings in which:

FIG. 1 is a perspective view illustrating an embodiment of a protective film unit;

FIG. 2 is a cross-sectional view taken along line I-I′ of FIG. 1;

FIG. 3 is a perspective view illustrating an embodiment of an outer film and an inner film of the protective film unit of FIG. 1;

FIG. 4 is a cross-sectional view taken along a line II-IF of the inner film of FIG. 3; and

FIGS. 5 through 10 are diagrams illustrating an embodiment of a method of assembling a panel using the protective film unit of FIG. 1.

### DETAILED DESCRIPTION OF CERTAIN INVENTIVE EMBODIMENTS

Particular structural and functional description of the inventive concept are provided in a descriptive sense only; various changes in form and details may be made therein and thus should not be construed as being limited to the embodiments set forth herein. As the inventive concept is not limited to the embodiments described in the present description, it should be understood that the inventive concept includes every kind of variation examples or alternative equivalents included in the spirit and scope of the inventive concept. In the description, the detailed descriptions of well-known functions and structures may be omitted so as not to hinder the understanding of the present invention.

In the present description, terms such as ‘first’, ‘second’, etc. are used to describe various elements. However, the elements should not be defined by these terms. The terms are used only for distinguishing one element from another element.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

An embodiment will be described in detail with reference to the accompanying drawings.

An embodiment of protective film unit protects a panel. The panel may be a touch panel, a sensor glass, or a display panel used in a touch screen device. Hereinafter, the panel is used as a term including all the above-described panels. The panel includes a first area disposed in a central portion of the panel and a second area disposed in edge portions surrounding the central portion of the panel. The first area may be an active area or a display area according to a type of the panel. The second area may be an inactive area or a non-display area. The second area is where a frame is attached.

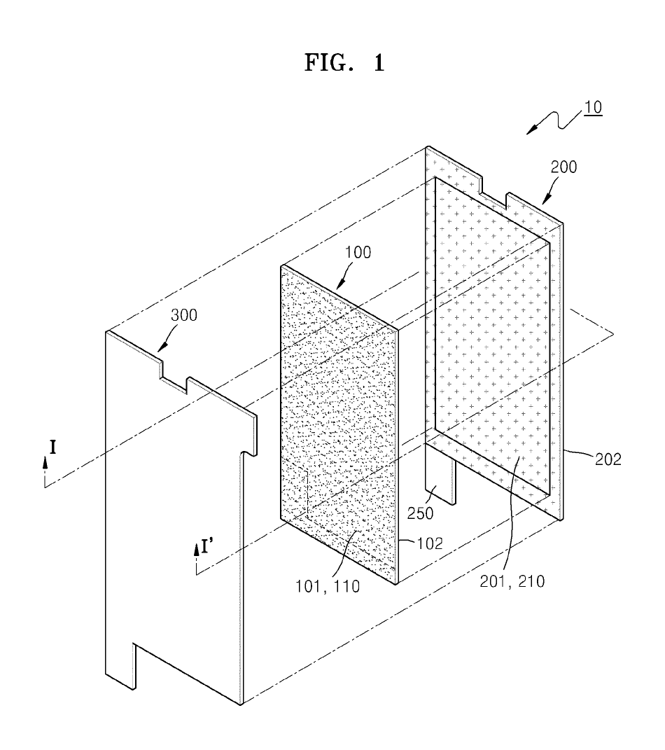

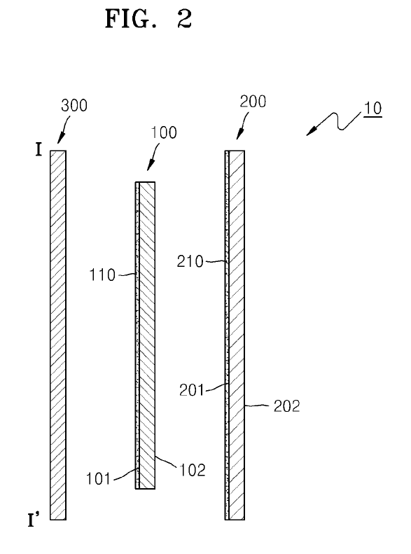

FIG. 1 is a perspective view illustrating an embodiment of a protective film unit 10. FIG. 2 is a cross-sectional view taken along line I-I′ of FIG. 1.

Referring to FIGS. 1 and 2, the protective film unit 10 includes a release film 300, an inner film 100, and an outer film 200.

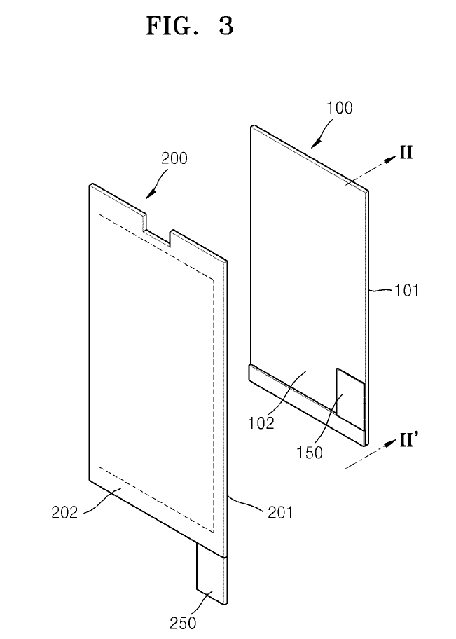

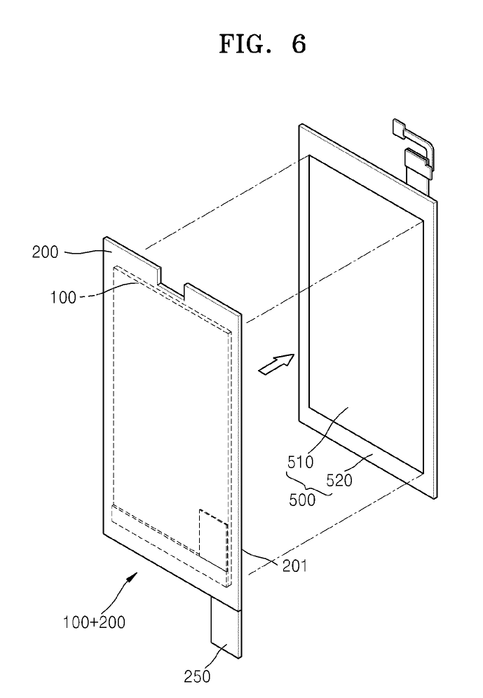

Referring to FIG. 6, the inner film 100 is attached to a first area 510 of the panel 500, and protects a central portion of the panel 500. The inner film 100 includes a first surface 101 and a second surface 102 which is an opposite surface to the first surface 101. A first adhesive material 110 is deposited on the entire first surface 101. The first surface 101 of the inner film 100 may be separated from the release film 300, and then may be attached to the first area 510 of the panel 500. The second surface 102 of the inner film 100 may further include a separating member 150 (see FIG. 3).

The first adhesive material 110 may include a urethane-based material and a silicon-based material. The first adhesive material 110 is entirely deposited on the first surface 101 of the inner film 100. The first adhesive material 110 may include a combination of a urethane-based material and a silicon-based material, and may be uniformly formed in edges of the inner film 100. The inner film 100 is formed by punching a plurality of films having a printing paper on which an adhesive material is deposited and by being separated. The adhesive material may move due to the punching process in the process of forming the inner film 100, thereby resulting in non-uniform agglomeration of the adhesive material in edges of the inner film 100. However, when an adhesive material including a combination of a urethane-based material and a silicon-based material is used, the adhesive material has a high hardness and thus does not easily move. Accordingly, even though the inner film 100 is punched, the adhesive material is uniformly formed in the edges of the inner film 100, and agglomeration or movement of the adhesive material does not occur. Therefore, the inner film 100 of the current embodiment may be firmly attached to the panel 500.

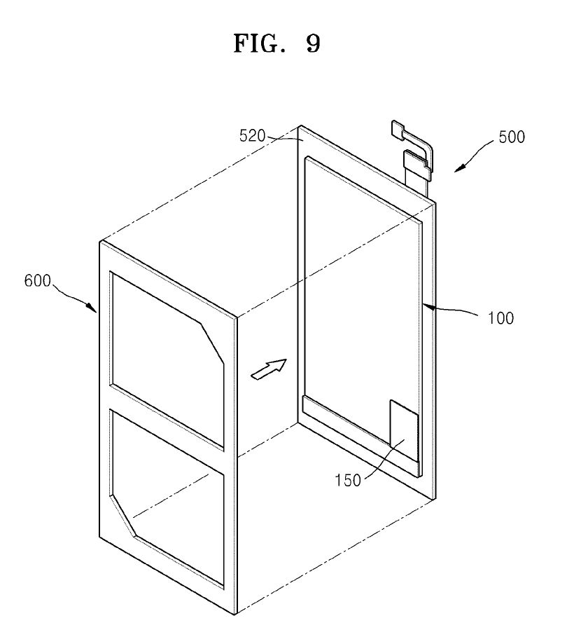

Referring to FIG. 9, the outer film 200 is attached to the inner film 100 so as to overlap with the inner film 100. The outer film 200 is attached to the second surface 102 of the inner film 100 and to the second area 520 of the panel 500, so that the outer film 200 may protect edges of the panel 500 before the frame 600 is attached to the panel 500. The outer film 200 includes a first surface 201 and a second surface 202 that is opposite to the first surface 201. A second adhesive material 210 is entirely deposited on the first surface 201 of the outer film 200. The outer film 200 is separated from the release film 300 when the outer film 200 overlaps with the inner film 100, and then may be attached to the second area 520 of the panel 500 when the outer film 200 overlaps with the inner film 100.

The second adhesive material 210 may include one or more materials selected from the group consisting of an acrylic-based material and a urethane-based material. The second adhesive material 210 is entirely deposited on the first surface 201 of the outer film 200. The second adhesive material 210 may include one or more materials selected from the group consisting of an acrylic-based material and a urethane-based material so as not to transfer an adhesive component to the second area 520 of the panel 500. A material used as the second adhesive material 210 has an elastic property, and thus an adhesive component does not remain in the panel 500 when the outer film 200 is removed, thereby increasing an adhesive property and a bonding property when the frame 600 is attached to the second area 520 of the panel 500 in subsequent processes.

The release film 300 is attached to a surface where an adhesive material is deposed on a combination of the inner film 100 and the outer film 200. The release film 300 is attached on the first surface 101 of the inner film 100 and on the first surface 201 of the outer film 200 that is exposed to the outside without being covered by the inner film 100. The release film 300 is attached only before the combination of the inner film 100 and the outer film 200 is attached to the panel 500, and is removed when an assembling process begins.

The release film 300 may prevent external substances from being attached to the first adhesive material 110 deposited on the first surface 101 of the inner film 100 and to the second adhesive material 210 deposited on the first surface 201 of the outer film 200. The release film 300 may also prevent deterioration of a bonding property due to the exposure to an external environment. A handle may be integrally formed with the release film 300 so as to easily grip and separate the release film 300.

The outer film 200 includes the separating tag 250. An edge of the outer film 200 extends to form the separating tag 250, and the separating tag 250 is integrally formed with the outer film 200. In some embodiments, the separating tag 250 may be formed to have a cantilever shape. A user or a machine may easily separate the outer film 200 from the panel 500 through the separating tag 250.

FIG. 3 is a perspective view illustrating the outer film 200 and the inner film 100 of an embodiment of the protective film unit 10 of FIG. 1. In FIG. 3, the outer film 200 and the inner film 100 are illustrated in reversed position as compared to the illustration of FIGS. 1 and 2. Accordingly, when comparing FIG. 3 with FIG. 1, a direction of a separating tag 250 of the outer film 200 is reversed, and a separating member 150 of the inner film 100 is further illustrated in FIG. 3. The separating member 150 is formed in the second surface 102 of the inner film 100. The separating member 150 is formed at an edge of the second surface 102 of the inner film 100.

According to one embodiment, an area of the inner film 100 is smaller than that of the outer film 200. The inner film 100 has an area corresponding to the first area 510 of the panel 500. The outer film 200 has an area corresponding to the first area 510 and the second area 520, so as to protect the entire surface of the panel 500 including the second area 520 before the frame 600 is attached to the panel 500. The inner film 100 protects only the first area 510 of the panel 500 after the outer film 200 is removed and the frame 600 is attached to the panel 500. Accordingly, the inner film 100 needs to have an area to cover only the first area 510 of the panel 500 so as not to affect the frame 600 to be attached to the panel 500. The outer film 200 may have an area to cover the entire area of the panel 500.

The panel 500 may be protected by using the protective film unit 10 in which the inner film 100 and the outer film 200 are sequentially stacked. Conventionally, the panel 500 has been protected by using a single protective film. However, when the frame 600 is attached to the panel 500, a protective film should be removed. Thus, when a single protective film is used, the first area 510 of the panel 500 is exposed to the outside during an additional process performed after the frame 600 is attached to the panel 500. According to some embodiments, the above-described problem is solved by configuring the protective film as a double structure, thereby reducing defects occurring in a process of assembling the panel 500.

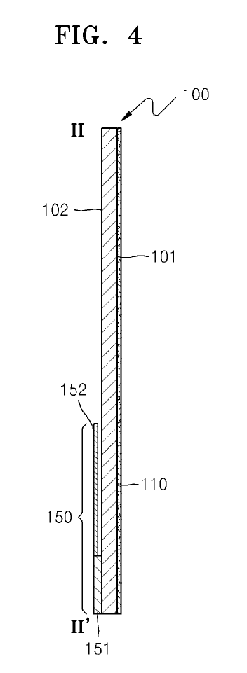

FIG. 4 is a cross-sectional view taken along a line II-IF of the inner film of FIG. 3. Referring to FIG. 4, the separating member 150 includes a contact portion 151 and a separating portion 152.

The contact portion 151 is attached to the second surface 102 of the inner film 100 so as to fix the separating portion 152. One end of the separating portion 152 is connected and fixed to the inner film 100 through the contact portion 151, and the other end thereof is spaced apart from the inner film 100 and thus may freely move. The separating portion 152 is connected to the contact portion 151, and thus the other end of the separating portion 152 may freely move, thereby allowing the other end of the separating portion 152 to be easily gripped. A user or a machine may grip the other end of the separating portion 152 so as to easily separate the inner film 100 from the panel 500.

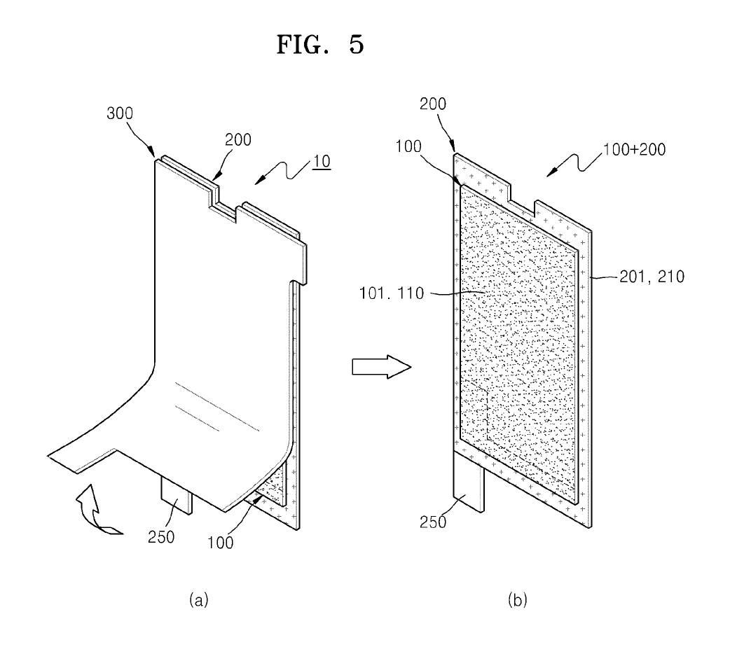

FIGS. 5 through 10 are diagrams illustrating an embodiment of a method of assembling the panel 500 using the protective film unit 10. FIGS. 5 through 10 illustrate a process of assembling the panel 500 and the frame 600 in a process of manufacturing a touch screen device.

Referring to FIG. 5, the protective film unit 10 is provided, and the release film 300 is removed from the protective film unit 10. In FIG. 5, (a) illustrates the protective film unit 10 in which the release film 300, the inner film 100, and the outer film 200 are sequentially stacked. A detailed configuration of (a) of FIG. 5 has been described with reference to FIGS. 1 and 2, and thus repeated description will be omitted. After the release film 300 is removed, a combination of the inner film 100 and the outer film 200 remains, wherein the first surface 101 deposited with the first adhesive material 110 is exposed, and wherein the outer film 200 overlaps with the inner film 100 and the first surface 201 deposited with the second adhesive material 210 is partially exposed.

Referring to FIG. 6, the combination of the inner film 100 and the outer film 200 of FIG. 5 is attached to a surface of the panel 500. In this regard, the panel 500 includes the first area 510 and the second area 520. The first surface 101 of the inner film 100 covers the first area 510 of the panel 500, and an exposed edge of the outer film 200 covers the second area 520 of the panel 500.

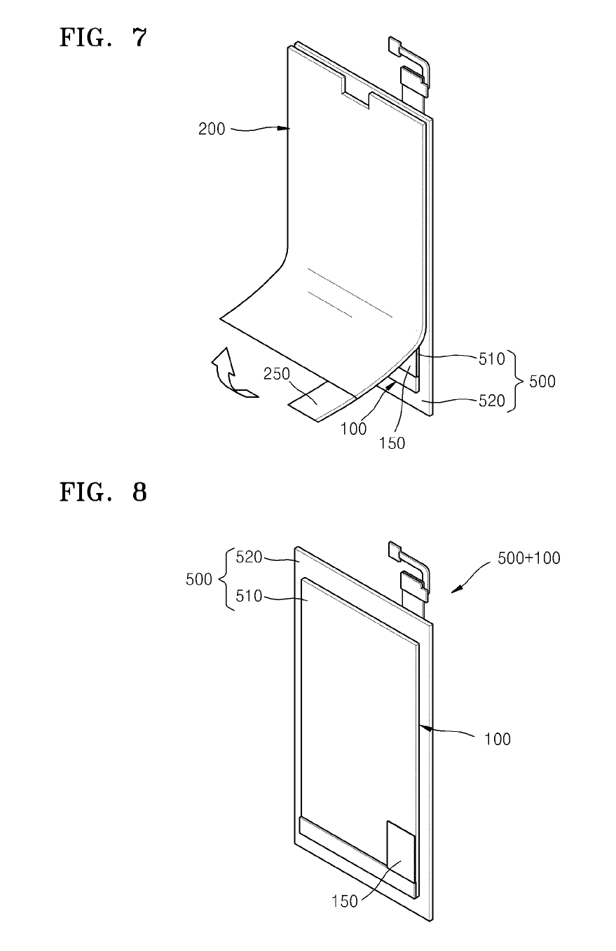

Referring to FIG. 7, the outer film 200 is removed. A user or a machine may easily remove the outer film 200 by gripping the separating tag 250 of the outer film 200.

Referring to FIG. 8, after the outer film 200 is removed, only the inner film 100 is attached to the first area 510 of the panel 500. In some embodiments, the second adhesive material 210 of the outer film 200 includes one or more materials selected from the group consisting of an acrylic-based material and a urethane-based material, and thus an adhesive component does not remain in the second area 520 of the panel 500.

Referring to FIG. 9, the frame 600 is attached to the panel 500 of FIG. 8. The frame 600 provides an area for coupling a flat display panel (not shown) and the panel 500. Except for edges of the frame 600, all surfaces thereof are open, and the frame 600 is attached to the panel 500 by using an adhesive material. A double-sided tape can be attached to or an adhesive material may additionally be deposited on the edges of the frame 600 corresponding to the second area 520 of the panel 500. In some embodiments, when the inner film 100 is attached to the first area 510 of the panel 500, the frame 600 is attached thereto. Thus, even though external substances enter through an opening of the frame 600, the first area 510 of the panel 500 may be protected from the external substances. The first area 510 of the panel 500 may be protected due to the inner film 100 in which the frame 600 is attached, and thus a more reliable product may be produced.

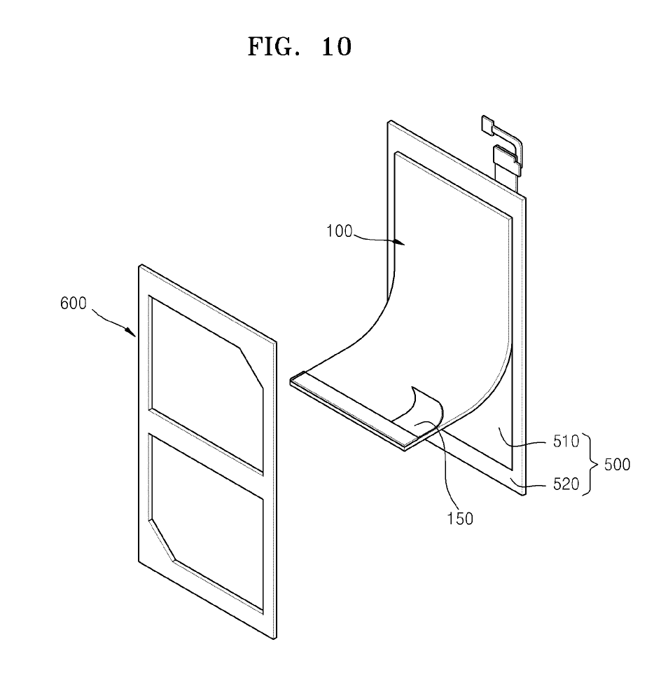

FIG. 10 illustrates a final process of assembling the frame 600 and the panel 500 of a touch screen device after removing the inner film 100.

When the inner film 100 is attached to the first area 510 of the panel 500, the frame 600 attached to the second area 520 of the panel 500 is removed from the panel 500. Next, the inner film 100 attached to the first area 510 of the panel 500 is removed. The inner film 100 may be easily removed by gripping the separating member 150 formed in the inner film 100.

Finally, the frame 600 is reattached to the panel 500 from which the inner film 100 is removed. The combination of the frame 600 and the panel 500 manufactured by performing the above-described process is attached to a display panel device (not shown) that is previously manufactured, thereby completing a touch screen device.

According to some embodiments, the inner film 100 is attached to the panel 500 before the combination of the frame 600 and the panel 500 is completed, thereby preventing external substances from being attached to an active area of the panel 500 and preventing defects from being generated in the active area of the panel 500.

In embodiments of the present invention, a panel used in a touch screen device has been described as an example. In other embodiments, the protective film unit 10 may be used in any display device including a combination of a frame and a panel.

According to embodiments, an inner film and an outer film are sequentially stacked, and the outer film and the inner film are removed in the stated order, so that the outer film may protect all surfaces of a panel before a frame is attached to the panel and so that the inner film may protect an active area of the panel after the frame is attached to the panel. Thus, the panel may be protected from an external environment even during assembling processes that are sequentially performed.

The outer film and the inner film use different adhesive components. In particular, an acrylic-based material and/or a urethane-based material, which do/does not easily move, are/is used as the adhesive component used in the outer film, and thus the frame and the panel may be easily attached to each other. The adhesive component of the inner film uses a combination of a urethane-based material and a silicon-based material, and thus when the inner film is formed by performing a punching process, the adhesive material may move due to the punching process, thereby maintaining uniformity of the adhesive material in edges of the inner film.

The inner film and the outer film have a structure for facilitating separation thereof, thereby increasing a process efficiency.

While the present invention has been particularly shown and described with reference to certain embodiments thereof, it will be understood by those of ordinary skill in the art that various changes in form and details may be made therein without departing from the spirit and scope of the present invention as defined by the following claims.

What is claimed is:

1. A protective film unit that is attached to a panel comprising a first area and a second area surrounding the first area, the protective film unit comprising:
an inner film attached to the entire surface of the first area, wherein a first adhesive material is entirely deposited on a first surface of the inner film corresponding to the first area; and
an outer film attached to a second surface of the inner film and to the second area, wherein a second adhesive material is entirely deposited on a first surface of the outer film corresponding to the second area and the second surface of the inner film.

2. The protective film unit of claim 1, wherein the first adhesive material comprises a combination of a urethane-based material and a silicon-based material.

3. The protective film unit of claim 1, wherein the second adhesive material comprises at least one of an acrylic-based material and a urethane-based material.

4. The protective film unit of claim 1, wherein an area of the inner film is smaller than that of the outer film.

5. The protective film unit of claim 1, wherein the inner film has an area corresponding to the first area of the panel.

6. The protective film unit of claim 1, further comprising a separating member formed at an edge of the second surface of the inner film,
wherein the separating member comprises a contact portion attached to the second surface of the inner film, and a separating portion of which one end is connected to the inner film through the contact portion and the other end is spaced apart from the inner film and is configured to be gripped.

7. The protective film unit of claim 1, further comprising a separating tag that is integrally formed with the outer film by extending an edge of the outer film, wherein the separating tag has a cantilever shape.

8. The protective film unit of claim 1, further comprising a release film attached to the first surface of the inner surface and the first surface of the outer film that is exposed to the outside without being covered by the inner film, wherein the release film, the inner film, and the outer film are sequentially stacked.

9. A method of assembling a panel using a protective film unit, the method comprising:
providing a panel comprising a first area and a second area surrounding the first area on a surface thereof;
providing a protective film unit in which a release film, an inner film, and an outer film are sequentially stacked;
removing the release film;
attaching the protective film unit, in which the inner film and the outer film are stacked, to the panel;
removing the outer film; and
attaching a frame to the second area of the panel when the inner film is attached to the first area of the panel,
wherein the protective film unit comprises:
an inner film attached to the entire surface of the first area, wherein a first adhesive material is entirely deposited on a first surface of the inner film corresponding to the first area; and
an outer film attached to a second surface of the inner film and to the second area, wherein a second adhesive material is entirely deposited on a first surface of the outer film corresponding to the second area and the second surface of the inner film.

10. The method of claim 9, wherein the first adhesive material comprises a combination of a urethane-based material and a silicon-based material.

11. The method of claim 9, wherein the second adhesive material comprises at least one of an acrylic-based material and a urethane-based material.

12. The method of claim 9, wherein the inner film further comprises a separating member formed at an edge of the second surface of the inner film.

13. The method of claim 12, further comprising:
removing the frame attached to the second area of the panel from the panel when the inner film is attached to the first area of the panel;
removing the inner film by gripping the separating member of the inner film attached to the first area of the panel; and
reattaching the frame to the second area of the panel from which the inner film is removed.

14. The method of claim 9, wherein the outer film further comprises a separating tag that is integrally formed with the outer film by extending an edge of the outer film, and wherein the separating tag has a cantilever shape.

15. The method of claim 14, wherein the removing of the outer film comprises removing the outer film by gripping the separating tag.
